(19) United States
(12) Patent Application Publication
(10) Pub. No.: US 2005/0261851 A1
(43) Pub. Date: Nov. 24, 2005

(54) Method for determining the curvature of a curve passing through a plurality of points

(75) Inventors: Daniel Buck, Blaubeuren (DE); Michael Diebel, Neckarsulm (DE); Sinan Kazan, Los Altos, CA (US); Alfred Lotter, Grafenau (DE); Martin Wenz, Wildberg (DE); Richard Zimmer, Fellbach (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/055,114

(22) Filed: Feb. 11, 2005

(30) Foreign Application Priority Data
Feb. 11, 2004 (DE) 10 2004 006 686.8

(51) Int. Cl. G01C 17/38

(52) U.S. Cl. 702/94

(57) ABSTRACT

In a method and apparatus for determining the curvature of a curve passing through a plurality of points, the shape of which is defined by a line connecting these points, curvature is assigned to the individual points by determining the position of adjacent points relative to the individual points. The curvature of a point (B) is determined by further taking into account two additional points (A, C), one of which (A) lies on the connecting line forward of the respective point (B) and the other (C) on the connecting line behind the respective point (B). The points (A, C) are determined such that they are as remote as possible from the respective point (B) and, at the same time, no points exist which lie between the respective point (B) and one of the additional points (A, C), and which are farther than a set distance from the connecting lines between the respective point (B) and each of the two additional points (A, C).

### BACKGROUND AND SUMMARY OF THE INVENTION

This application claims the priority of German patent document 10 2004 006 686.8, filed Feb. 11, 2004, the disclosure of which is expressly incorporated by reference herein.

The invention relates to a method and apparatus for determining the curvature of a curve passing through a plurality of points.

03 German patent document DE 196 04 364 A1 discloses such a method, in which a plurality of points are connected in pairs by connecting lines. Curvatures of the resulting trajectory are then determined by establishing which points belong to what are referred to as elementary curves. The curvature radii are then determined for these elementary curves.

One object of the present invention is to provide a method for describing a path with respect to its curvatures.

In particular, it is an object of the invention to provide such a method and apparatus which is suitable to describe roads in digitized maps.

Another object of the invention is to provide a system for controlling operating parameters of a vehicle based on curvature of the route ahead.

These and other objects and advantages are achieved by the method and apparatus according to the present invention, in which the curvature at a point (B) is determined by reference to two additional points (A, C), one of which (A) lies on a connecting line forward of the respective point (B) and the other (C) on a connecting line behind the respective point (B). The points (A, C) are selected so that they are as remote as possible from the point (B), with no points existing which lie between the respective point (B) and one of the two additional points (A, C), and which have a distance greater than a threshold value from the connecting lines between the respective point (B) and each of the two additional points (A, C).

It has been found that this selection of three points, by means of which the curvature radius is determined at point B, has the advantageous result that an appropriate selection of points can be achieved, particularly if the curvatures are slight (i.e., the curvature radii are large). Because the points are as remote from each other as possible, numerical problems can be largely avoided. In addition to potential numerical problems, it is also possible to avoid problems caused by inaccuracies in the position of the points, which can occur when the points are spaced closely together (particularly when the curvatures are slight) and can lead to inaccuracies in determining the curvature. By taking into account not only the distance between points but also the threshold value, it is possible to compensate inaccuracies in the position of individual points. If the points lie outside the band defined by the threshold value, it can be assumed that this is no longer an inaccuracy in the definition of the position of the corresponding point but a position of the point corresponding to a course of the road.

Hence, with the present method, a curvature can be assigned to each point. The value of the curvature assigned to the points at the start and at the end of a band can be the corresponding value of the adjacent point. The value of the curvature of these two points can also be set at “0”.

In one embodiment of the method, only those points (A, B, C) which have a minimum distance from each other are used for the calculation of the curvature.

In another embodiment of the invention, a curvature is calculated only if the points have a sufficient distance from each other: if problems are expected with respect to the reliability of the information provided by the calculation, the calculation of the curvature at the corresponding point is omitted entirely.

In still another embodiment, the curvature at point B is determined according to the radius of a circle that passes through points A, B and C. For this purpose, the curvature is determined on the basis of the radius of the circle circumscribed by these three points.

In yet another embodiment of the invention the curvature at point B is determined according to the radius of the circle which passes through point B, and further passes through the one of the two points A and C that is closest to from point B. A third point of the circular line is obtained by marking off, starting from point B, a segment on the connecting line between point B and the point (A or C) that is farther from point B which segment corresponds to the distance from point B to the point (A or C) that is closer to point B.

By following this procedure, the circle can be calculated more easily using the symmetries.

According to a further embodiment, the curvature at point B is determined according to the radius of the circle passing through the one of the two points A and C that is closest to point B. A third point of the circular line is obtained by marking off, starting from point B, a segment on the connecting line between point B and the point (A or C) that is farther from point B, which segment corresponds to the distance from point B to the point (A or C) that is closer to point B. To calculate the circle, the position of point B is obtained by moving point B along the bisector of the two points A, C away from the connecting line between points A and C, such that the displacement depends on the distance of point B from the connecting line between points A and C.

Particularly if the curvatures are relatively sharp, it is an advantage that this procedure makes it possible to achieve a homogeneous course of the values along the curve.

According to another embodiment of the invention, the curvature is further determined using in addition the points directly adjacent to point B. The curvature at point B is set at the smaller absolute value if the determined curvatures described previously if the determined curvatures have different signs.

Finally, the invention also includes a vehicle control system that regulates vehicle operating parameters of a vehicle based on curvature of the road ahead of the vehicle, in the manner described above.

It has been found that, with this procedure, the informative value can be improved if the respective point lies at the summit of relatively tight curves or if the points are set imprecisely on segments with a slight curvature.

With the present invention, it is possible to determine the curvatures of curves defined as two-dimensional point sequences. The points are used as sampling points to represent the course of a road or a traffic lane of a digitized map. All points should lie within a band. Furthermore, the direct connecting lines between the points should extend within the band.

If the number of the points used to define the path is to be reduced, it is also possible, in principle, to delete all points between the three points which are used to determine the curvature of the leg of the trajectory at the location of the point lying in the center of these three points. This technique has the advantage of saving memory space. The course of the path, particularly in the area with sharper curvatures, is still supported by a sufficient number of sampling points.

Other objects, advantages and novel features of the present invention will become apparent from the following detailed description of the invention when considered in conjunction with the accompanying drawings.

### BRIEF DESCRIPTION OF THE DRAWINGS

FIG. 1 is a diagram illustrating the shape of a curve;

FIG. 2 is a diagram of the geometric quantities in the triangle ABC for determining the circumscribed circle;

FIG. 3 is a diagram illustrating the improvement in the case of slighter curvatures;

FIG. 4 is a diagram for determining a circle;

FIG. 5 illustrates the conditions in tight curves;

FIG. 6 illustrates the conditions in the case of imprecisely set points in wide curves; and

FIG. 7 shows a representative embodiment of a vehicle control system according to the invention.

### DETAILED DESCRIPTION OF THE DRAWINGS

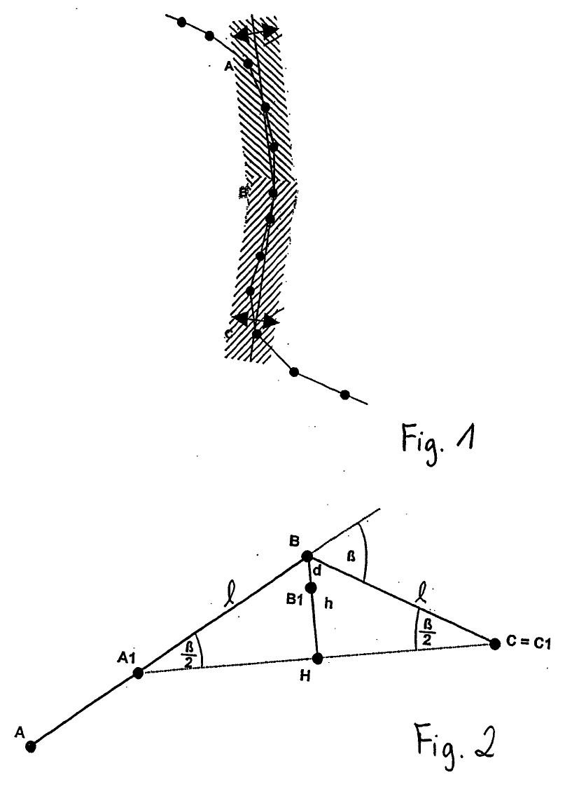

FIG. 1 is a diagram of a curve in which three points A, B and C are marked. The shape of the curve is defined by additional points, which are also plotted. The curvature of the curve at point B is to be determined. For this purpose, adjacent points A and C are selected for the calculation, based on the following criteria:
The adjacent points A and C should be as remote as possible from point B; and
Between the individual adjacent points (A and C) and point B there should be no point which lies on the curve and whose distance from the straight line between point B and the respective adjacent point (A or C) exceeds a set maximum (representative by the cross hatch “band” in FIG. 1).

The following additional criterion may furthermore be used:
The distance between the adjacent point A, C and point B must be a specific minimum distance.

Using the above criteria, points are defined with which the course of the curvature can be reproduced as smoothly as possible. Any inaccuracies in the definition of the position of the points can be largely compensated.

FIG. 2 shows the relevant quantities used to determine the curvature radius of the curve at point B.

First, the distances between points A and B and between points B and C are calculated:
|AB|={square root over (((x_{B} x_{A})²+(y_{B} y_{A})²))}
|BC|={square root over (((x_{C} x_{B})²+(y_{C} y_{B})²))}

In addition, the angle, is calculated as follows:
cos(β)=((x_{B}−x_{A})*(x_{C}−x_{B})+(y_{B}−y_{A})*(y_{C}−y_{B}))/(|AB|*|BC|)
From this, the sine value of half of the angle can be determined:
sin(β/2)={square root over (((1 cos(β)/2))}

To make the calculation of the curvature simpler and therefore quicker, an isosceles triangle A1BC1 can be formed from the triangle ABC. The shorter of the two sections from B to A or from B to C is marked off along the longer of the two sections starting from point B. The chord length l=|A1B|=|BC1| of the new triangle is obtained according to the following equation, taking into account h=|BH|≦hₘₐₓ:
1=min( min(|AB|,|BC|),(hₘₐₓ/sin(β)/2)))
The distance h=|BH| can then be calculated:
h=1/sin(β/2)

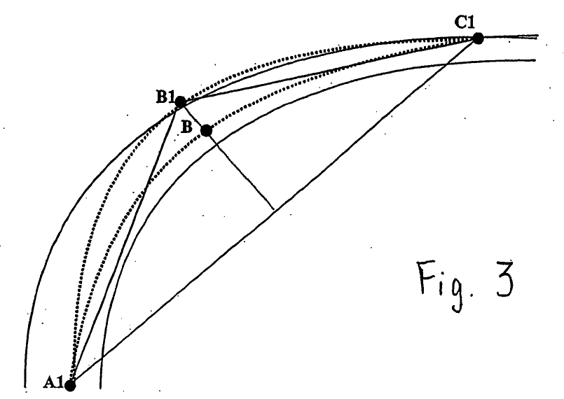

If the distance h is large, it may be assumed that at this particular location the point sequence reproduces only imprecisely the shape of the curvature of the band to be represented. This effect can be countered by shifting point B along the bisector between AB and BC, as shown in FIG. 3. The point is shifted away from the connecting line between the points A1 and C1.

The distance between the original point B and the new point B1 is then determined using a constant factor:
d=h*factor

For a smoothing correction, a factor value of between 0 and 1 should be used.

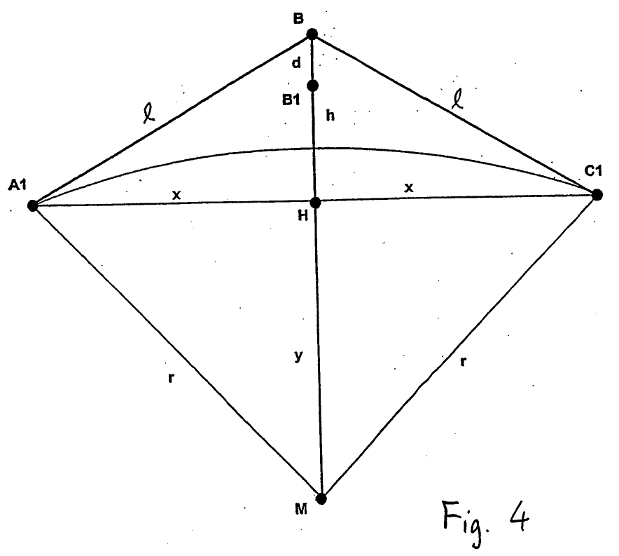

FIG. 4 shows an example of the calculation of the circle. A circle is to be drawn through points A1, B1, C1, and its radius is to be determined. The radius of the circle is to coincide as precisely as possible with that of the band represented by the point sequence. The radius can be derived from the following three equations:
r²=x²+y²
l²=h²+x²
r+d=y+h
where:r=|MA1|=|MB1|=|MC1|
y=|MH|
x=|A1H|=|HC1|

Inserting the equations gives the following formula for the calculation of the radius r of the circle drawn through the three points A1, B1 and C1:
r=(l²+d²−2*d*h)/(2*(h−d))

Substituting h with h=1* sin(β/2) and solving for sin(β/2) gives a maximum critical angle for a defined minimum radius rₘᵢₙ.
sin(β/2)=(l²+d²−2*d*rₘᵢₙ)/(2*1*(rₘᵢₙ+d))

For angles between 0<sin(β/2)<sin(β/2)ₘₐₓ the signed curvature kr at point B1 can be calculated from the following equation:
kr=Sign((x_{B}−x_{A})*(y_{C}−y_{B})−(x_{C}−x_{B})*(y_{B}−y_{A}))*1/r

For all other angles, the signed curvature kr at point B1 results from:
kr=Sign((x_{B}−x_{A})*(y_{C}−y_{B})−(x_{C}−x_{B})*(y_{B}−y_{A}))*1/rₘᵢₙ
where the following holds:
positive curvatures correspond to a left-hand curve,
negative curvatures correspond to a right-hand curve.

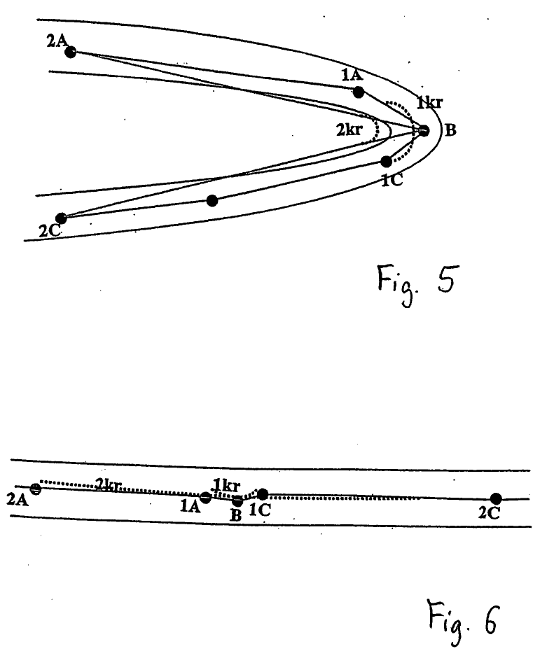

FIG. 5 shows the conditions in tight curves. It can be derived therefrom that, apart from the criteria established for the selection of the points, the curvature at the point can in addition be calculated directly from the adjacent points. This value is then compared with the previous value. If the two values have the same sign, the smaller absolute value is subsequently used. If the two values have different signs, the value that was determined by means of the more remote points is then used.

In the example shown in FIG. 5, the curvature 1kr is determined from the directly adjacent points 1A and 1C and point B. The curvature 2kr is determined for more remote points using the described selection procedure. The two values of the curvatures thus determined have the same sign. Point B is assigned the curvature with the smaller absolute value (1kr). It may be seen that the calculated curvature value 2kr would be too large for the actual conditions at point B.

FIG. 6 shows the conditions for points that are set too imprecisely in wide curves. The curvature 1kr is again determined from the adjacent points 1A and 1C. The curvature 2kr is again determined by means of the more remote points 2A and 2C using the described procedure. Both curvatures again have the same sign, such that the curvature with the smaller absolute value (2kr) is assigned to point B.

The method specified for describing curves makes it possible to control the output of information for the driver of a vehicle. Using a navigation system in addition, relevant information can be output before the corresponding waypoints are reached. It is furthermore possible to use the described data to intervene directly in the control systems of a vehicle. This can be, for example, an automatic speed selection, where the desired speed can be appropriately reduced before curves, for instance. Likewise, the headlight field can be adjusted in anticipation of curves through which the vehicle has to pass.

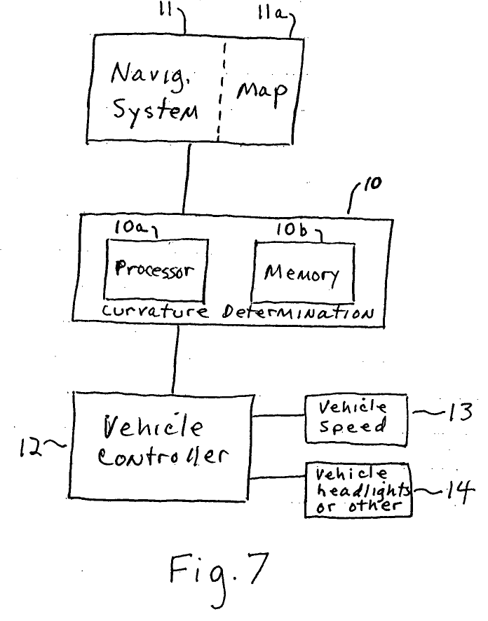

FIG. 7 shows an example of a vehicle control system according to the invention which controls vehicle operating parameters, such as vehicle speed or headlight elevation or azimuth. For this purpose, a device 10 for determining curvature of a route ahead of the vehicle includes a data processor 10a and a memory 10b for storing application software for causing the data processor to perform curvature calculations. For this purpose, the device 10 is coupled to a navigation system 11, which accesses a digital map 11a that contains digitized information describing the geographic course of routes within a navigation area. In particular, the routes within the map are defined by a large number of points through which they pass.

The data processor 10a reads map information from the map 11a and determines the curvature of a route forward of the vehicle according to the computer program stored in the memory 10b, using the technique described previously. It then provides the determined curvature information to a controller 12, which in turn controls one or more vehicle system based thereon. For example, it may control the vehicle speed to accommodate curves in the road ahead, or adjust the aiming direction of the headlights so that they point in the direction of a curve. Other vehicle systems may of course also be controlled in the same manner.

As is apparent, the conceptual diagram of the control system in FIG. 7 is illustrative only, and the system according to the invention can be implemented in a variety of ways. Each of the components may be implemented as a separate hardware or software element, as part of a distributed processing system, or integrated into a single controller. For example, the map information 11a and the program in memory 10b may likewise be stored locally, in organic memory, or remotely. And all three of the components (navigation system 11, curvature determination 10 and vehicle controller 12) may be combined in a single computer, or may utilize functionality that is dispersed throughout a computer network.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A computer readable medium encoder with a program for determining the curvature of a curve that passes through a plurality of points, the shape of the curve being defined by a line connecting these points; said program comprising means for causing a computer to assign a curvature to individual points on the curve by determining the position of adjacent points relative to the individual points; wherein:
the curvature at a particular point (B) is determined by taking into account at least two additional points (A, C), a first one of which lies on a connecting line forward of the particular point, and the other of which lies on a connecting line behind the particular point (B);
the location of the additional points (A, C) are determined such that they are as remote as possible from the respective point (B), while at the same time no points exist which lie on the curve between the particular point (B) and either of the two additional points (A, C), and which have a distance greater than a threshold value from the respective connecting lines between the point (B) and each of the two additional points (A, C).

2. The computer readable medium as claimed in claim 1, wherein for the calculation of the curvature, only points which have a minimum distance from each other are used.

3. The computer readable medium as claimed in claim 2, wherein the curvature at the particular point B is determined according to the radius of a circle that passes through points A, B and C.

4. The computer readable medium as claimed in claim 2, wherein:
the curvature at the particular point B is determined according to the radius of a circle that passes through point B and through that one of the two additional points (A, C) which is closer to point B; and
a third point (A1, C1) for determining the curvature is obtained by marking off, starting from point B, a segment on a connecting line between point B and the additional point (A or C) that is farther from point B, which segment corresponds to a distance from point B to the point (A or C) that is closer to point B.

5. The computer readable medium as claimed in claim 2, wherein:
the curvature at point B is determined according to the radius of a circle passing through that one of the two additional points (A or C) which is closer to point B;
a third point (A1 or C1) for determining the curvature is obtained by marking off, starting from point B, a segment on a connecting line between point B and the additional point (A or C) that is farther from point B, which segment corresponds to a distance from point B to the point (A or C) that is closer to point B;
a changed position of point B for the calculation of the circle is obtained by displacing point B along a bisector of the two additional points (A, C) to a further point (B1), away from the connecting line between points A and C; and
the magnitude of such displacement depends on a distance of point B from the connecting line between points A and C.

6. The computer readable medium as claimed claim 5, wherein:
a second curvature at point B is further determined by means of points which are immediately adjacent to point B;
the curvature at point B is set to a smaller absolute value if the previously determined curvature and the second curvature have the same sign; and
the curvature at point B is set to the previously determined value if the determined curvatures have different signs.

7. Apparatus for controlling operation of a vehicle comprising:
a vehicle navigation system, which accesses a digital map containing map information defining routes over which the vehicle may be operated;
a device for determining curvature of said routes based on said information in said map; and
a controller for controlling an operating parameter of said vehicle, based on curvature determined by said device for points on a traveled route ahead of the vehicle; wherein,
routes contained in said digital map are defined by a line connecting points through which said routes pass; and
the device for determining curvature of said routes comprises a data processor and a computer readable medium encoded with a computer program for causing said data processor to perform the following steps:
assigning a curvature to individual points on the curve by determining the position of adjacent points relative to the individual points; wherein, the curvature at a particular point (B) is determined by taking into account at least two additional points (A, C), a first one of which lies on a connecting line forward of the particular point, and the other of which lies on a connecting line behind the particular point (B);
the location of the additional points (A, C) are determined such that they are as remote as possible from the respective point (B), while at the same time no points exist which lie on the curve between the particular point (B) and either of the two additional points (A, C), and which have a distance greater than a threshold value from the respective connecting lines between the point (B) and each of the two additional points (A, C).

8. The apparatus according to claim 7, wherein said operating parameter comprises at least one of vehicle speed and vehicle headlight angle.

9. The apparatus as claimed in claim 7, wherein for the calculation of the curvature, only points which have a minimum distance from each other are used.

10. The apparatus as claimed in claim 9, wherein the curvature at the particular point B is determined according to the radius of a circle that passes through points A, B and C.

11. The apparatus as claimed in claim 9, wherein:
the curvature at the particular point B is determined according to the radius of a circle that passes through point B and through that one of the two additional points (A, C) which is closer to point B; and
a third point (A1, C1) for determining the curvature is obtained by marking off, starting from point B, a segment on a connecting line between point B and the additional point (A or C) that is farther from point B, which segment corresponds to a distance from point B to the point (A or C) that is closer to point B.

12. The apparatus as claimed in claim 9, wherein:
the curvature at point B is determined according to the radius of a circle passing through that one of the two additional points (A or C) which is closer to point B;
a third point (A1 or C1) for determining the curvature is obtained by marking off, starting from point B, a segment on a connecting line between point B and the additional point (A or C) that is farther from point B, which segment corresponds to a distance from point B to the point (A or C) that is closer to point B;
a changed position of point B for the calculation of the circle is obtained by displacing point B along a bisector of the two additional points (A, C) to a further point (B1), away from the connecting line between points A and C; and
the magnitude of such displacement depends on a distance of point B from the connecting line between points A and C.

13. The apparatus as claimed claim 12, wherein:
a second curvature at point B is further determined by means of points which are immediately adjacent to point B;
the curvature at point B is set to a smaller absolute value if the previously determined curvature and the second curvature have the same sign; and
the curvature at point B is set to the previously determined value if the determined curvatures have different signs.

14. A device for determining curvature of a curve that passes through a plurality of points, the shape of the curve being defined by a line connecting said points, said device comprising:
a data processor coupled to a memory having stored therein information containing data designating points which define said curve; and
a computer readable medium accessible by said data processor and encoded with a computer program for causing said data processor to perform the following steps,
assigning a curvature to individual points on the curve by determining the position of adjacent points relative to the individual points; wherein,
the curvature at a particular point (B) is determined by taking into account at least two additional points (A, C), a first one of which lies on a connecting line forward of the particular point (B), and the other of which lies on a connecting line behind the particular point (B);
the location of the additional points (A, C) are determined such that they are as remote as possible from the respective point (B), while at the same time no points exist which lie on the curve between the particular point (B) and either of the two additional points (A, C), and which have a distance greater than a threshold value from the respective connecting lines between the point (B) and each of the two additional points (A, C).

15. The device as claimed in claim 14, wherein for the calculation of the curvature, only points which have a minimum distance from each other are used.

16. The device as claimed in claim 15, wherein the curvature at the particular point B is determined according to the radius of a circle that passes through points A, B and C.

17. The device as claimed in claim 15, wherein:
the curvature at the particular point B is determined according to the radius of the circle that passes through point B and through that one of the two additional points (A, C) which is closer to point B; and
a third point (A1, C1) for determining the curvature is obtained by marking off, starting from point B, a segment on a connecting line between point B and the additional point (A or C) that is farther from point B, which segment corresponds to a distance from point B to the point (A or C) that is closer to from point B.

18. The device as claimed in claim 15, wherein the curvature at point B is determined according to the radius of a circle passing through that one of the two additional points (A or C) which is closer to point B;
a third point (A1 or C1) for determining the curvature is obtained by marking off, starting from point B, a segment on a connecting line between point B and the additional point (A or C) that is farther from point B, which segment corresponds to a distance from point B to the point (A or C) that is closer to point B;
a changed position of point B for the calculation of the circle is obtained by displacing point B along a bisector of the two additional points (A, C) to a further point (B1), away from the connecting line between points A and C; and
the magnitude of such displacement depends on a distance of point B from the connecting line between points A and C.

19. The device as claimed claim 18, wherein:
a second curvature at point B is further determined by means of points which are immediately adjacent to point B;
the curvature at point B is set to a smaller absolute value if the previously determined curvature and the second curvature have the same sign; and
the curvature at point B is set to the previously determined value if the determined curvatures have different signs.
